(19) United States
(12) Patent Application Publication
(10) Pub. No.: US 2025/0109030 A1
(43) Pub. Date: Apr. 3, 2025

(54) PROCESS FOR PRODUCING A HIGH-PURITY ALUMINA

(71) Applicants: ADITYA BIRLA SCIENCE AND TECHNOLOGY COMPANY PRIVATE LIMITED, Maharashtra, Navi Mumbai (IN); HINDALCO INDUSTRIES LIMITED, Maharashtra, Mumbai (IN)

(72) Inventors: Chandrakala KARI, Maharashtra, Navi Mumbai (IN); Mangesh JADHAV, Maharashtra, Navi Mumbai (IN); Ranga RAO, Maharashtra, Navi Mumbai (IN); Vilas TATHAVADKAR, Maharashtra, Navi Mumbai (IN)

(21) Appl. No.: 18/833,087

(22) PCT Filed: Jan. 19, 2023
(86) PCT No.: PCT/IB2023/050449

§ 371 Date: Jul. 25, 2024

(30) Foreign Application Priority Data
Jan. 25, 2022 (IN) 202221005741

(51) Int. Cl. C01F 7/42; C01F 7/306; C01F 7/56

(52) U.S. Cl. CPC C01F 7/42; C01F 7/306; C01F 7/56; C01P 2006/80

(57) ABSTRACT

Provided herein is a process for producing a high-purity alumina, comprising the steps of: (a) sublimation of anhydrous aluminium chloride at a predetermined temperature to recover pure aluminium chloride; (b) dissolving aluminium chloride from step (a) in water to obtain aluminium chloride solution; (c) introducing HCl gas into aluminium chloride solution of step (b) to crystallize aluminium chloride hexahydrate; and (d) calcining aluminium chloride hexahydrate of step (c) to obtain high purity alumina.

### FIELD OF THE INVENTION

The present invention relates to a process for producing high purity alumina.

### DESCRIPTION OF THE BACKGROUND ART

Alumina of different grades with different levels of purity and physical properties are used for various applications such as ceramics, fillers and high-end applications such making of sapphire single crystals, semi-conductor, lithium-ion battery applications etc. The properties such as chemical inertness, electrical resistance and its stability to high operating temperature are used in various applications. The purity requirements are stringent not only with respect to total content of impurities limited to <100 ppm but also to achieve individual limits for each critical element such as Na<30 ppm, Si<20 ppm, Fe—3-5 ppm. All other impurities need to be controlled <3 ppm.

Bayer process is the primary process by which alumina is extracted in the form of aluminium hydroxide. In Bayer process bauxite is dissolved in a caustic soda (NaOH) solution and subjected to heating, and precipitating the aluminium hydroxide. Most of the alumina produced worldwide is used for smelter grade applications, which is of 99.7% purity. The aluminium hydroxide produced by the Bayer process also contains elemental impurities from the bauxite.

The two major processes for the manufacturing of high purity alumina that are practiced commercially are (i) Alkoxide process from Aluminium metal (ii) Acid route from Aluminous clay. The alkoxide process contributes to 80% of total HPA requirements which uses aluminium metal as starting material and processes its alkoxide in multistage distillation to achieve desired purity levels. The advantages of this process are simpler process, easy to serve different grades of alumina as well as having control on particle size by controlling hydrolysis (Shinji F. et. al, 2007). However, the major challenges include higher cost raw material, very slow reaction kinetics for the formation of alkoxide from metal which is further used to make even fine metal powders. Although the aluminum ingots or metal powders used are of high purity, still the presence of critical impurities like iron (500-1500 ppm) and silicon (400-800 ppm) is unavoidable.

Therefore, there is a series of distillation process for purification of aluminium alkoxides from its other complex alkoxides especially that are formed with silica (Bains M. S, 1962 & Jeffrey H et. al, 1986).

Another process for high purity alumina production is the acid route from aluminous clay, which uses special aluminous clay from Australian deposit having very low iron (0.7%) and alkali content (Na₂O<0.1%). The process for preparation of high purity alumina from special aluminous clay through said acid route is recited in EP3530623A1, AU 2018101228A4 and AU2019204216 A1.

The process uses HCl for the digestion of clay after roasting at 400° C. (which breaks the structure of aluminium silicates). The subsequent purification steps involve removal of iron and other impurities with the selective precipitation of AlCl₃·6H₂O by increasing the concentration of HCl using anhydrous HCl (Lewis J. C., 1951). The number of purification stages depends on the concentration of impurities present in the clay. Yves Noel, 2012 discloses a similar technology, for production of high purity alumina which is more chemical & energy intensive.

US20180155206A1 recites a method of producing high-purity nano alumina powder in which general aluminum hydroxide is dissolved in a sodium hydroxide solution to give a sodium aluminate solution, most insoluble impurities other than sodium are removed using a micro filter to give a pure sodium aluminate solution. A seed is added thereto so as to precipitate nano aluminum hydroxide as a nano slurry under optimal precipitation conditions. The nano aluminum hydroxide slurry is filtered, dried, disintegrated, and then calcined at a low temperature of 900° C. or less, thus achieving the mass production of high-purity nano alumina.

U.S. Pat. No. 8,124,048B2 recites a method of producing high purity alumina in which an Si content, an Fe content, a Ca content, and an Na content are simultaneously removed.

WO2018040998A1 discloses a method for preparing an ultra-pure spherical alumina powder, wherein gas-phase aluminum chloride is pneumatically conveyed and sprayed into a heating zone of greater than or equal to 2500° C., then the ultra-pure aluminum chloride is pyrolyzed to produce alumina, thereby obtaining an ultra-pure spherical alumina powder.

The major challenges involved are handling the variations in impurities of raw material as well as huge amount of acid waste generated in multistage purification steps.

Therefore, the presently developed new processes for HPA production are aimed at achieving target purities with minimal number of processing/purification steps. This is obtained by a unique combination of purification steps to control different metallic impurities based on boiling points, selectivity in crystallization etc.

### SUMMARY OF THE INVENTION

The present invention is conceived to solve the aforementioned problems.

It is an object of the present invention to provide a method for preparing high-purity alumina.

Another specific object of the invention is to provide a method for preparing high-purity alumina using anhydrous aluminium chloride.

In an aspect, the present invention provides a method for preparing high purity alumina begins with sublimation of anhydrous aluminium chloride. The sublimation process was carried out at a specific temperature to recover pure aluminium chloride either as solid or gas.

Aluminium chloride recovered in the form of either gas or solid, is further dissolved in water to obtain aluminium chloride solution. Subsequently, anhydrous HCl gas is introduced into aluminium chloride solution which results in crystallization of aluminium chloride precipitating as aluminium chloride hexahydrate. Crystallized aluminium chloride hexahydrate is subjected to calcination to obtain high purity alumina >99.99% (4N).

### BRIEF DESCRIPTION OF THE DRAWINGS

The foregoing summary, as well as the following detailed description of the invention will be better understood when read in conjunction with the appended drawings. For the purpose of assisting in the explanation of the invention, there are shown in the drawings embodiments which are presently preferred and considered illustrative. It should be understood, however, that the invention is not limited to the precise arrangements and instrumentalities shown therein. In the drawings:

FIG. 1 is a process flow sheet for the production of high purity alumina from anhydrous aluminium chloride according to an embodiment of the invention.

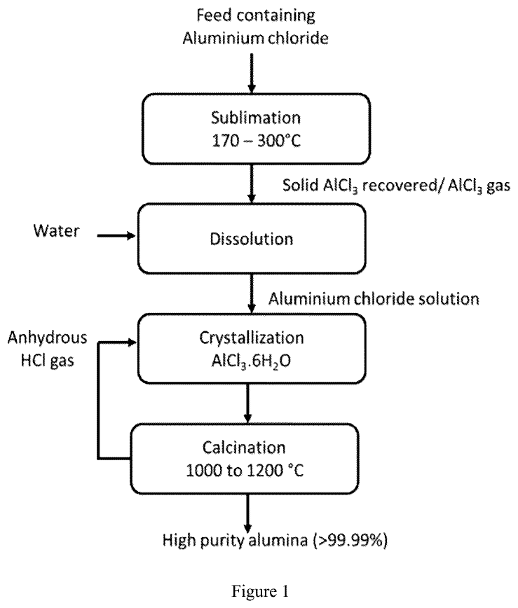

FIG. 2 is a process flow sheet for the production of high purity aluminium hydrate from anhydrous aluminium chloride according to an embodiment of the invention.

### DESCRIPTION OF THE INVENTION

In describing and claiming the invention, the following terminology will be used in accordance with the definitions set forth below. Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described herein. As used herein, each of the following terms has the meaning associated with it in this section. Specific and preferred values listed below for individual process parameters, substituents, and ranges are for illustration only; they do not exclude other defined values or other values falling within the preferred defined ranges.

As used herein, the singular forms “a,” “an,” and “the” include plural reference unless the context clearly dictates otherwise.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, the terms “comprising” “including,” “having,” “containing,” “involving,” and the like are to be understood to be open-ended, i.e. to mean including but not limited to.

As used herein, “sublimation” refers to the conversion of the solid and the gaseous phases of matter directly when subjected to heating.

As used herein “calcination” refers to the heating of solids to a high temperature for the purpose of removing volatile substances (chlorides, hydroxides, carbonates etc) and forming targeted phase transitions.

As used herein, the term “4N grade” refers to 99.99% purity of samples with total of impurities 100 ppm.

Although any methods and materials similar or equivalent to those described herein can be used in the practice or testing of the present invention, the preferred methods and materials are described. All publications and other references mentioned herein are incorporated by reference in their entirety. Numeric ranges are inclusive of the numbers defining the range.

The conventional methods of preparing high purity alumina, are generally energy intensive and results in waste by-products. From the foregoing, the inventors of the present invention have extensively studied on a process for producing a high-purity alumina in which elemental metals as impurity are substantially removed. As a result, the inventors have proposed a process for preparing high purity alumina that involves selection of unique combination of purification steps based on the impurities found in feedstock.

In an embodiment, anhydrous aluminium chloride/chloride feedstock is generated by carbo-chlorination/chlorination from any aluminous feed stocks such as bauxite, aluminium hydrate, aluminium dross or red mud etc.

That is, the present invention provides a process for producing a high-purity alumina, comprising the steps of:
(a) sublimation of anhydrous aluminium chloride at a predetermined temperature to recover pure aluminium chloride;
(b) dissolving aluminium chloride from step (a) in water to obtain aluminium chloride solution;
(c) introducing HCl gas into aluminium chloride solution of step (b) to obtain crystallized aluminium chloride hexahydrate; and
(d) calcining crystallized aluminium chloride hexahydrate of step (c) to obtain high purity alumina.

The heating of step (a) is carried out at a temperature in the range of 170 to 300° C. to facilitate sublimation. Sublimation of anhydrous aluminium chloride results to obtain pure aluminium chloride.

During sublimation, impurities are selectively separated. Low boiling point impurities such as chlorides of silicon, arsenic and titanium are selectively removed by eliminating the fraction of vapours below the boiling point of aluminium chloride, lower than 170° C., preferably between 50° C. to 130° C. Subsequently, aluminium chloride is heated to a temperature in the range of 170° C. to 300° C. This eliminates several other metallic chlorides having higher boiling points than aluminium chloride such as Iron, Zinc, Nickel, Lead, Sodium etc.

In a further embodiment of the invention, discarding at least a part of sublimated anhydrous aluminium chloride, preferably 5 wt % at the beginning and at the end of sublimation process, improves the high purity material production of Aluminium chloride (AlCl₃) and further Aluminium hydroxide (Al(OH)₃), Aluminium oxide (Al₂O₃).

Aluminium chloride, devoid of impurities, gets collected as gas, which may be subsequently cooled below a temperature of 170° C. to obtain solid aluminium chloride as powder or granules or taken forward in the gaseous form without cooling for dissolution in water and further processing. The residue generated the sublimation process contains the graphite impurities as well as inorganic impurities such as iron, zinc, lead, sodium and other chlorides which have higher boiling points.

In an embodiment, sublimation is carried out in the presence or absence of carrier gas. The carrier gas is preferably an inert gas, such as nitrogen or argon.

In another embodiment the pure aluminium chloride obtained from sublimation may be collected as a solid product or in gaseous form.

The gaseous or solid pure aluminium chloride obtained from sublimation is dissolved in water to obtain aluminium chloride solution. The temperature of the solution is maintained at <50° C. to avoid the losses of aluminium chloride.

In an embodiment, gases generated during sublimation can be directly passed through the water spraying column/absorption units to produce aluminium chloride solution with a concentration of aluminium chloride in the range of 100-400 gm per litre or in other words 10-40% aluminium chloride in the solution.

In another embodiment, the solid generated during sublimation can be directly dissolved in water to produce aluminium chloride solution with a concentration of aluminium chloride in the range of 100-400 gm per litre or in other words 10-40% aluminium chloride in the solution.

The aluminium chloride solution is further subjected to purification based on their solubility in highly super saturated acid solution of HCl (+36%). The aluminium chloride solution is super saturated by enriching with HCl using anhydrous HCl gas while maintaining temperature in the range of 25-65° C. till the saturation of HCl reaches 30-40%. In an embodiment, anhydrous Cl₂, AlCl₃ or any chlorine containing gasses can be used.

On achieving saturation of HCl in the range of 30-40% aluminium chloride hexahydrate (AlC₃·6H₂O) crystallizes. Impurities such as Arsenic, Silicon, Zinc and Iron having higher solubility in acidic solutions gets separated in this process as they remain in solution.

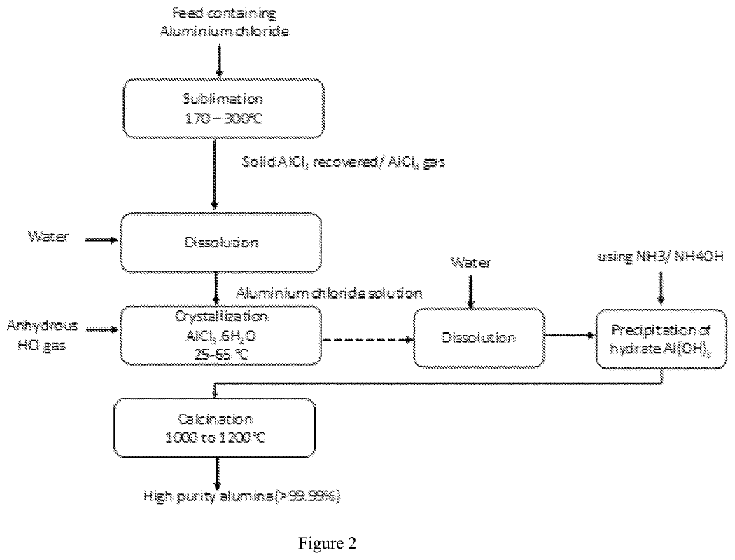

In another embodiment, as shown in FIG. 2, at least some part of aluminium chloride hexahydrate is further dissolved in water and reacted with ammonia or ammonium hydroxide to precipitate ultrahigh pure aluminium hydroxide for specialized applications. The aluminium hydroxide is further calcinated to obtain high purity alumina.

In an embodiment, impurities can be minimized by controlling rate of crystallization of aluminium chloride hexahydrate (AlCl₃·6H₂O) by controlling the flow rate of HCl gas, initial concentration of the aluminium chloride solution and temperature. In another embodiment, aluminium chloride hexahydrate seed crystals may be added in the crystallization step.

In an embodiment, the sublimation and the crystallization steps may be repeated more than once to produce high purity alumina materials of 4N, 5N or 6N (+99.99) etc.

Aluminium Chloride hexahydrate precipitate is calcined at a temperature in the range of 1000-1100° C. to obtain high purity alumina (HPA).

In another embodiment of the present invention the sublimation and/or crystallization step may be combined with any other purification methods known in the art, such as, solvent extraction/organic precipitation, to prepare high purity aluminium hydrate or alumina of purity >99.99%.

The final HPA product obtained by this process is of 99.99% purity and qualifies the stringent quality criteria specified for 4N grade. In an embodiment, calcination is carried out at stages of temperature, specifically at 90° C., 360° C. and 1000-1100° C. to recover the HCl & chlorine evolved during the process which is then recycled.

The process of present application successfully minimized the impurities present in the alumina to the level of Na<20 ppm, Si<10 ppm, Fe<1 ppm, and all other impurities lower than 3 ppm. The produced material is suitable for high purity alumina applications such as sapphire single crystal making, coating application in Lithium Ion Batteries, LED, etc.

The conventional methods of production of high purity alumina demands multiple purification steps to achieve desired purity requirements. However, the process claimed in present applications takes into consideration, the critical impurities present in the feed stock and devising an approach to separate the impurities. Hence, high purity alumina or aluminium hydrate is produced with minimal number of steps.

In addition, the process of present application generates less quantities of side streams thereby ensuring sustainability of the process with maximum recycle. Further, the process of present application is less chemical/energy intensive.

### Working Example

The following specific example is illustrative and explanatory of the present invention but are not to be construed as limiting the scope of the invention.

Anhydrous aluminium chloride produced by chlorination of aluminium metal was used as feed stock. Aluminium metal ingots contain impurities of Na: 10-100 ppm, Si: 400-1000 ppm, Fe: 580-1500 ppm, V: 50-150 ppm, Ti: 50 ppm. Since the process of chlorination of molten aluminium metal was carried out at very high temperatures 600-700° C., the metallic impurities form their chlorides is reported along with aluminium chloride.

### Example 1

Anhydrous aluminium chloride was heated at a temperature in the range 170° C. to 300° C. to undergo sublimation. The aluminium chloride after sublimation was dissolved in water to obtain aluminium chloride solution. HCl gas was purged into the aluminium chloride solution at a temperature of 25-65° C. to allow crystallization of aluminium chloride hexahydrate. The precipitated crystallized aluminium chloride hexahydrate was calcined at a temperature of 1100° C. to obtain high purity alumina.

### Example 2

In the process of example 1, sublimation was repeated twice and the crystallization of aluminium chloride hexahydrate in acid medium was carried out in single stage resulted in increased purity of alumina by controlling critical impurities such as Na, Si, K, Zn etc.

### Example 3

In the process of example 1, sublimation was carried out in single step in combination with two stages crystallization of aluminium chloride hexahydrate, resulted in producing further high purity alumina by controlling major metallic impurities <0.5 ppm.

Purity of alumina produced by these processes of present application are shown in Table 1.

TABLE 1

| Impurities | Raw Material | | | |
|---|---|---|---|---|
| (ppm) | AlCl₃ | Example 1 | Example 2 | Example 3 |
| Na | 30-50 | 20 | 10 | <10 |
| Fe | 40-100 | <1 | <1 | <0.5 |
| Si | 100-250 | <10 | <5 | <1 |
| K | 10 | <5 | <2 | <1 |
| Ca | 20 | <3 | <3 | <3 |
| Mg | 6-10 | <3 | <3 | <0.5 |
| Cr | — | <0.5 | <0.5 | <0.5 |
| As2O3, Sb2O3 | 10 | <1 | <1 | <0.5 |
| Mn, Ni, Sn, Co, | — | <0.5 | <0.5 | <0.5 |
| V, Zr | | | | |
| Pt, Ni, Pb, Ti | — | <1 | <1 | <0.5 |
| Zn | 5-10 | <3 | <3 | <0.5 |
| Graphite/other | 0.3-0.5% | 0 | 0 | 0 |
| undissolved | | | | |
| acid residue | | | | |
| Loss on Ignition | — | <0.5% | <0.5% | <0.5% |

### Example 4

In the process of example 1, instead of calcining the crystallized aluminium chloride hexahydrate to obtain alumina, its is used to prepared aluminium hydroxide. The crystallized aluminium chloride hexahydrate is redissolved in water and ammonium hydroxide is as added until the pH is 6. Therefore, aluminium hydroxide is precipitated which is filtered and dried at 105° C. to obtain moisture free product.

Further, the precipitated aluminium hydroxide was calcined at a temperature of 1100° C. to obtain high purity alumina.

The purity of aluminium hydroxide obtained is given in Table 2 and is of 599.99% pure.

TABLE 2

| Impurities (ppm) | Raw Material AlCl₃ | Example 4 |
|---|---|---|
| Na | 30-50 | <30 |
| Fe | 40-100 | <5 |
| Si | 100-250 | <30 |
| K | 10 | <5 |
| Ca | 20 | <10 |
| Mg | 6-10 | <3 |
| Cr | — | <0.5 |
| As₂O₃, Sb₂O₃ | 10 | <1 |
| Mn, Ni, Sn, Co, V, Zr | — | <1 |
| Pt, NI, Pb, Ti | — | <1 |
| Zn | 5-10 | <3 |
| Graphite/other | 0.3-0.5% | 0 |
| undissolved acid residue | | |
| Loss on Ignition | — | 35-40% |

The foregoing description of the invention is illustrative and explanatory thereof. Various modifications will become apparent to those skilled in the art in view of the present disclosure. It is intended that all such variations which fall within the scope and spirit of the appended claims be embraced thereby.

We claim:

1. A process for producing a high-purity alumina, comprising the steps of:
(a) sublimation of anhydrous aluminium chloride at a predetermined temperature to recover pure aluminium chloride;
(b) dissolving aluminium chloride from step (a) in water to obtain aluminium chloride solution;
(c) introducing HCl gas into aluminium chloride solution of step (b) to crystallize aluminium chloride hexahydrate; and
(d) calcining aluminium chloride hexahydrate of step (c) to obtain high purity alumina.

2. The process as claimed in claim 1, wherein sublimation of step (a) is a two stage process wherein anhydrous aluminium chloride is subjected to heating at different temperatures.

3. The process as claimed in claim 2, wherein said two stage sublimation is carried out at a temperature between 50° C. to 170° C. and 170° C. to 300° C.

4. The process as claimed in claim 1, wherein said sublimation is carried out until 95-97% of aluminium chloride is recovered from anhydrous aluminium chloride.

5. The process as claimed m claim 1, wherein sublimation of step (a) may be repeated at least 4 times.

6. The process as claimed in claim 1, optionally, said sublimation is carried out in presence of carrier gas.

7. The process as claimed in claim 1, wherein aluminium chloride obtained in step (a) is either gas or solid.

8. The process as claimed in claim 1, wherein dissolution of aluminium chloride in step (b) is carried out at temperature between 30-50° C.

9. The process as claimed in claim 1, wherein step (b) is repeated at least 4 times.

10. The process as claimed in claim 1, wherein introduction of HCl gas in step (c) is carried out a temperature in the range of 25-65° C.

11. The process as claimed in claim 1, wherein, optionally, aluminium chloride hexahydrate seed crystals are added during step (c).

12. The process as claimed in claim 1, wherein calcination Is carried out at a temperature in range of 1000° C. to 1200° C.

13. The process as claimed in claim 1, wherein calcination is carried out until the loss on ignition is less than 0.5%.

14. The process as claimed in claim 1, optionally, crystallized aluminium chloride hexahydrate of step (c) is dissolved in water and reacted with ammonia or ammonium hydroxide to obtain high purity aluminium hydroxide.

15. The process as claimed in claim 14, comprising calcinating said high purity aluminium hydroxide to obtain high purity alumina.
